(19) United States
(12) Patent Application Publication
(10) Pub. No.: US 2023/0335745 A1
(43) Pub. Date: Oct. 19, 2023

(54) ALL-SOLID-STATE BATTERY INCLUDING CATHODE ACTIVE MATERIAL LAYER HAVING INCREASED THICKNESS AND METHOD OF MANUFACTURING SAME

(71) Applicants: HYUNDAI MOTOR COMPANY, Seoul (KR); KIA CORPORATION, Seoul (KR)

(72) Inventors: Ju Yeon Lee, Busan (KR); Tae Young Kwon, Daegu (KR); Young Jin Nam, Suwon-si, Gyeonggi-do (KR); Gyeong Jun Chung, Daejeon (KR); Jong Jung Kim, Suwon-si, Gyeonggi-do (KR); Yoon Jae Han, Yongin-si, Gyeonggi-do (KR); Sang Mo Kim, Hwaseong-si, Gyeonggi-do (KR); Sung Hoo Jung, Changwon-si, Gyeongsangnam-do (KR)

(73) Assignees: Hyundai Motor Company, Seoul (KR); Kia Corporation, Seoul (KR)

(21) Appl. No.: 18/074,937

(22) Filed: Dec. 5, 2022

(30) Foreign Application Priority Data
Dec. 10, 2021 (KR) 10-2021-0176175

(51) Int. Cl. H01M 4/62; H01M 10/058

(52) U.S. Cl. CPC H01M 4/625; H01M 10/058

(57) ABSTRACT

The present disclosure relates to an all-solid-state battery including a cathode active material layer having an increased thickness and to a method of manufacturing the same.

### CROSS REFERENCE TO RELATED APPLICATION

The present application claims priority to Korea Patent Application Publication No. 10-2021-0176175, filed Dec. 10, 2021 in the Korea Intellectual Property office, the entire contents of which is incorporated herein for all purposes by this reference.

### TECHNICAL FIELD

The present disclosure relates to an all-solid-state battery including a cathode active material layer having an increased thickness and to a method of manufacturing the same.

### BACKGROUND

An all-solid-state battery may include a cathode active material layer disposed on a cathode current collector, an anode active material layer disposed on an anode current collector, and a solid electrolyte layer interposed between the cathode active material layer and the anode active material layer.

The cathode active material layer may include a cathode active material containing lithium as a main component. The cathode active material layer may further include a solid electrolyte conducting lithium, a conductive material conducting electrons, and a binder attaching electrode elements.

A battery is required to have high energy density, high output power, and long lifetime. In particular, for high power performance, electrons must be able to move easily from the cathode active material to the cathode current collector.

Recently, high energy densities have been required for batteries in demand for electric vehicles, and thus there has been an attempt to increase the thickness of a cathode. However, when a thick cathode is used, the electron conduction path from the cathode active material to the cathode current collector increases. Therefore, the thick cathode is disadvantageous in exhibiting high power performance. In addition, it becomes difficult to separate lithium ions, so that utilization rate of the cathode active material is lowered and the energy density is reduced.

To compensate for this, an attempt has been made to increase the amount of a conductive material in a slurry. However, an excessive amount of conductive material may result in reaction with a solid electrolyte, thereby degrading the cell performance.

### SUMMARY OF THE DISCLOSURE

An objective of the present disclosure is to provide an all-solid-state battery including a cathode active material layer having an increased thickness, a high energy density, and a high power output and to provide a method of manufacturing the same.

However, the objectives of the present disclosure are not limited the one described above. The objectives of the present disclosure will become more apparent from the following description and will be realized with components recited in the claims and combinations of the components.

In one embodiment according to the present disclosure, an all-solid-state battery may include an anode current collector, an anode active material layer, a solid electrolyte layer, a cathode active material layer, and a cathode current collector that are stacked in this order.

The cathode active material layer may include: a first layer disposed on the cathode current collector and including a fiber-type conductive material and a particle-type conductive material; and a second layer disposed on the solid electrolyte and including a fiber-type conductive material and a particle-type conductive material.

The first layer may have a higher first amount of the fiber-type conductive material than a first amount of the particle-type conductive material.

The second layer may have a higher second amount of the particle-type conductive material than a second amount of the fiber-type conductive material.

The specific surface area of the fiber-type conductive material may be equal to or less than one quarter of the specific surface area of the particle-type conductive material.

The first layer may include an amount of about 60% to 90% by weight of the fiber-type conductive material and an amount of about 10% to 40% by weight of the particle-type conductive material based on a total amount of the fiber-type conductive material and the particle-type conductive material in the first layer.

The second layer may include an amount of about 10% to 40% by weight of the fiber-type conductive material and an amount of about 60% to 90% by weight of the particle-type conductive material based on the total amount of the fiber-type conductive material and a particle-type conductive material in the second layer.

The cathode active material layer may have a thickness of about 100 to 350 μm.

The ratio (d₁/d₂) of the thickness (d₁) of the first layer to the thickness (d₂) of the second layer may be in a range of about 0.5 to 1.

The first layer may have a thickness of about 50 to 150 μm.

The second layer may have a thickness of about 50 to 200 μm.

The first layer and the second layer may be integrated without having a bonding interface.

The first layer may further include a binder, and the amount of the binder may satisfy Equation 1.

an amount of the binder in the first layer[% by weight]=2[% by weight]−the first amount of the fiber-type conductive material[% by weight] based on a total amount of the fiber-type conductive material and the particle-type conductive material in the first layer/100. [Equation 1]

The second layer may further include a binder, and the amount of the binder may satisfy Equation 2.

an amount of the binder in the second layer[% by weight]=2[% by weight]−the second amount of the fiber-type conductive material[% by weight] based on a total amount of the fiber-type conductive material and the particle-type conductive material in the second layer/100. [Equation 2]

In one embodiment according to the present disclosure, a method of manufacturing an all-solid-state battery includes: preparing a first slurry including a cathode active material, a solid electrolyte, a binder, a fiber-type conductive material, and a particle-type conductive material at predetermined amounts; preparing a second slurry including a cathode active material, a solid electrolyte, a binder, a fiber-type conductive material, and a particle-type conductive material at predetermined amounts; and applying the first slurry to a substrate to foam a first layer; and applying the second slurry to the first layer before the first layer is dried, to form a second layer.

The method may further include: sequentially stacking an anode current collector, an anode active material layer, a solid electrolyte layer, a cathode active material layer including the first layer and the second layer, anode active material layer, and a cathode current collector.

According to the present disclosure, it is possible to obtain an all-solid-state battery having a cathode active material layer having a high energy density and a high power output.

According to the present disclosure, it is possible to obtain an all-solid-state battery manufactured with a fiber-type conductive material with a small specific surface area to inhibit a side reaction between a solid electrolyte and the conductive material, thereby having an increased lifespan.

According to the present disclosure, it is possible to obtain an all-solid-state battery having a reduced binder amount to prevent problems caused by the migration of the binder, such as deterioration in performance and adhesion and increase in resistance.

However, the advantages of the present disclosure are not limited thereto. It should be understood that the advantages of the present disclosure include all effects that can be inferred from the description given below.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 shows an all-solid-state battery according to the present disclosure;

FIG. 2 shows a cathode active material layer according to the present disclosure;

FIG. 3A shows a scanning electron microscope (SEM) image of a cross section of a cathode active material layer according to the present disclosure;

FIG. 3B shows an SEM image of a cross section of a cathode active material layer according to Comparative Example 1;

FIG. 3C shows an SEM image of a cathode active material layer according to Comparative Example 2;

FIG. 4 shows the lifespan of the all-solid-state batteries according to Example, Comparative Example 1, and Comparative Example 2;

FIG. 5 shows increases in resistance after 20 cycles of charging and discharging of the all-solid-state batteries according to Example, Comparative Example 1, and Comparative Example 2; and

FIG. 6 shows an electrode resistance value of a cathode active material layer according to Example and the sum of the resistance values of first layer and second layer.

### DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Tams used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprise”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities.

The term “about” further may refer to a range of values that are similar to the stated reference value. In certain embodiments, the term “about” refers to a range of values that fall within 10, 9, 8, 7, 6, 5, 4, 3, 2, 1 percent above or below the numerical value (except where such number would exceed 100% of a possible value or go below 0%) or a plus/minus manufacturing/measurement tolerance of the numerical value. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

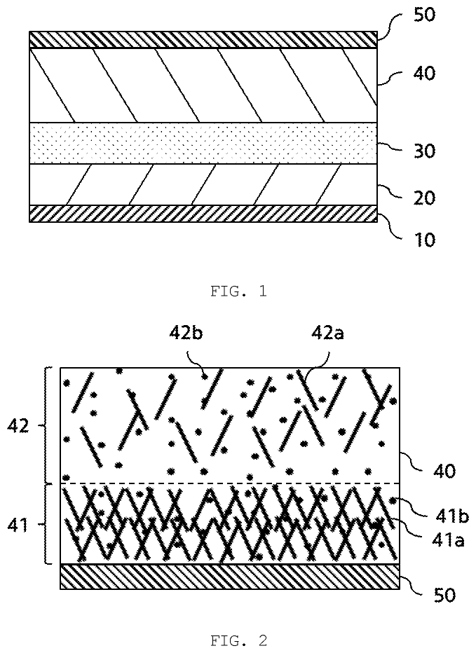

FIG. 1 shows an all-solid-state battery according to the present disclosure. The all-solid-state battery may include a stack of an anode current collector 10, an anode active material layer 20, a solid electrolyte layer 30, a cathode active material layer 40, and a cathode current collector 50.

The anode current collector 10 may be an electrically conductive plate-shaped substrate. The anode current collector layer 10 may be in the form of a sheet, a thin film, or a foil.

The anode current collector 10 may include a material that does not react with lithium. The anode current collector 10 may include at least one material selected from the group consisting of Ni, Cu, stainless steel (SUS), and combinations thereof.

The anode active material layer 20 may include an anode active material, a solid electrolyte, a binder, and the like.

The anode active material is not particularly limited, but may be, for example, a carbon active material or a metal active material.

The carbon active material may include graphite such as mesocarbon microbeads (MCMB) and highly oriented graphite (HOPG) or may include amorphous carbon such as hard carbon and soft carbon.

The metal active material may include In, Al, Si, Sn, or an alloy containing at least one of these elements.

The solid electrolyte may include an oxide-based solid electrolyte or a sulfide-based solid electrolyte. However, it is preferable to use a sulfide-based solid electrolyte having high lithium ion conductivity.

The sulfide-based solid electrolyte is not particularly limited, but examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS², Li₂S—SiS²—LiI, Li₂S—SiS²—LiBr, Li₂S—SiS²—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂-LiₓMO_{y} (here, x and y are positive integers, and M is any one of P, Si, Ge, B, Al, Ga, and In), and Li₁₀GeP₂S₁₂.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The solid electrolyte layer 30 may provide conduction path of lithium ions between the anode active material layer 20 and the cathode active material layer 40.

The solid electrolyte layer 30 may include an oxide-based solid electrolyte or a sulfide-based solid electrolyte. However, it is preferable to use a sulfide-based solid electrolyte having high lithium ion conductivity.

The sulfide-based solid electrolyte is not particularly limited, but examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂-LiₓMO_{y} (here, x and y are positive integers, and M is any one of P, Si, Ge, B, Al, Ga, and In), and Li₁₀GeP₂S₁₂

The cathode active material layer 40 may be a thicker film than conventional cathode active material layers. Conventional cathode active material layers have a low energy density because they are relatively thin. Simply thickening the cathode active material layer to achieve a high energy density lengthens the electron transfer path in the cathode active material layer, thereby significantly reducing the power output of the battery. On the other hand, when the amount of the conductive material in the cathode active material layer is increased to increase the power output of the battery, the area of contact between the conductive material and the solid electrolyte is increased, resulting in blocking the lithium ion transfer path. Therefore, the lifespan of the battery is reduced.

The present disclosure features that the thickness of the cathode active material layer 40 is increased without causing the problems described above.

FIG. 2 shows the cathode active material layer 40 according to the present disclosure. The cathode active material layer 40 may include a first layer 41 disposed on the cathode current collector 50 and a second layer 42 disposed on the solid electrolyte layer 30.

The cathode active material layer 40 may include fiber-type conductive material 41a and 42a and particle-type conductive material 41b and 42b. In the cathode active material layer, electrons move first along the fiber-type conductive material 41a and 42a and then rapidly spread out in the form of tree branches through the wide-spread particle-type conductive material 41b and 42b.

The fiber-type conductive material 41a and 42a may include at least one selected from the group consisting of carbon fibers, carbon nanotubes, vapor grown carbon fibers, and combinations thereof.

The particle-type conductive material 41b and 42b may include at least one selected from the group consisting of carbon black, conducting graphite, ethylene black, and combinations thereof.

In order to optimize the movement of electrons in the cathode active material layer 40, the amount of the fiber-type conductive material 41a is increased in the first layer 41 positioned on the side of the cathode current collector 50 where the transfer of electrons begins, so that the electrons can move quickly. And the amount of the particle-type conductive material 42b is increased in the second layer 42 so that the electrons may spread in a wider range. That is, the first layer 41 has a higher amount of the fiber-type conductive material 41a than the amount of the particle-type conductive material 41b, and the second layer 42 has a higher amount of the particle-type conductive material 42b than the amount of the fiber-type conductive material 41b.

The first layer may include an amount of about 60% to 90% by weight of the fiber-type conductive material and an amount of about 10% to 40% by weight of the particle-type conductive material based on a total amount of the conductive materials contained therein. The second layer may include an amount of about 10% to 40% by weight of the fiber-type conductive material and an amount of about 60% to 90% by weight of the particle-type conductive material based on a total amount of the conductive materials contained therein.

The specific surface area of each of the fiber-type conductive materials 41a and 42a may be less than or equal to one quarter of the specific surface area of each of the particle-type conductive materials 41b and 42b. The lifespan of the battery can be improved by using the fiber-type conductive materials 41a and 42a having a relatively small specific surface area to prevent a side reaction between the electrode and the solid electrolyte.

The cathode active material layer 40 may have a thickness of about 100 to 350 μm. Considering that conventional cathode active material layers have a thickness smaller than 100 μm or smaller than 50 μm, the cathode active material layer 40 is relatively thick.

The ratio (d1/d2) of the thickness (d1) of the first layer to the thickness (d2) of the second layer may be in a range of about 0.5 to 1. When the ratio is less than 0.5, the effect of accelerating the movement of electrons through the first layer 41 may be insignificant. On the other hand, when the ratio is greater than 1, the use of the fiber-type conductive material may be unnecessarily large.

The first layer 41 may have a thickness of about 50 μm to 150 and the second layer 42 may have a thickness of about 50 μm to 200 μm.

The present disclosure features that there is no bonding interface between the first layer 41 and the second layer 42 so that the electrical resistance of each of the first layer 41 and the second layer 42 is not increased. This will be described later.

The cathode active material layer 40 may include a cathode active material, a solid electrolyte, a fiber-type conductive material, a particle-type conductive material, and a binder.

For example, the cathode active material layer 40 may include an amount of about 70% to 90% by weight of the cathode active material, an amount of about 10% to 30% by weight of the solid electrolyte, an amount of about 1% to 2% by weight of the fiber-type conductive material, an amount of about 1% to 2% by weight of the particle-type conductive material, and an amount of about 1% to 2% by weight of the binder.

The cathode active material is not particularly limited, but may include, for example, an oxide active material or a sulfide active material.

The oxide active material may include a rock salt layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which transition metals are partially substituted with dissimilar metals, such as LiNi_{0.8}Co_{(0.2-x)}AlₓO₂ (0<x<0.2), a spinel-type active material in which transition metals are partially substituted with dissimilar metals, such as Li₁₊ₓMn_{2-x-y}M_{y}O₄ (M is at least one of Al, Mg, Co, Fe, Ni, and Zn, and 0<x+y<2), or a lithium titanate such as Li₄Ti₅O₁₂.

The sulfide active material may include copper Chevrel, iron sulfide, cobalt sulfide, nickel sulfide, or the like.

The solid electrolyte may include an oxide-based solid electrolyte or a sulfide-based solid electrolyte. However, it is preferable to use a sulfide-based solid electrolyte having high lithium ion conductivity.

The sulfide-based solid electrolyte is not particularly limited, but examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂-LiₓMO_{y} (here, x and y are positive integers, and M is any one of P, Si, Ge, B, Al, Ga, and In), and Li₁₀GeP₂S₁₂.

The fiber-type conductive materials 41a and 42a have an overall or local net structure in the cathode active material layer 40. That is, the fiber-type conductive materials 41a and 42a may contribute to improved adhesion between the components of the cathode active material layer 40. Therefore, according to the present disclosure, it is possible to reduce the amount of the binder in the cathode active material layer 40.

Specifically, the amount of the binder in the first layer 41 may be determined to satisfy Equation 1.

An amount of the binder in the first layer [% by weight]=2 [% by weight]−an amount of the fiber-type conductive material [% by weight] based on a total amount of the fiber-type conductive material and the particle-type conductive material in the first layer/100. [Equation 1]

Specifically, the amount of the binder in the second layer 42 may be determined to satisfy Equation 2.

An amount of the binder in the second layer [% by weight] =2 [% by weight]−an amount of the fiber-type conductive material [% by weight] based on a total amount of the fiber-type conductive material and the particle-type conductive material in the second layer/100. [Equation 2]

As described above, by reducing the ratio of the amount of the binder to the amount of the fiber-type conductive material, it is possible to prevent deterioration of performance and deterioration of adhesion, attributable to the movement of the binder in the cathode active material layer 40, and to reduce the resistance attributable to the presence of the binder.

The cathode current collector 50 may be an electrically conductive plate-shaped substrate. The cathode current collector 50 may be in the form of a sheet or a thin film.

The cathode current collector 50 may include at least one selected from the group consisting of In, Cu, Mg, Al, stainless steel (SUS), Fe, and combinations thereof.

A method of manufacturing the cathode active material layer for the all-solid-state battery, according to the present disclosure, may include: preparing a first slurry including the cathode active material, the solid electrolyte, the binder, the fiber-type conductive material, and the particle-type conductive material in specific contents; preparing a second slurry including the cathode active material, the solid electrolyte, the binder, the fiber-type conductive material, and the particle-type conductive material in specific contents; applying the first slurry to a substrate to form the first layer; and applying the second slurry to the first layer before the first layer is dried to form the second layer.

The amount of each of the components of the first slurry and the second slurry may be adjusted according to the amount of each of the components of the first layer and the second layer.

The first slurry and the second slurry may be prepared by adding and dispersing each of the components in a solvent. The types of solvents are not particularly limited, and any type of solvent can be used if the solvent can disperse each of the components without reacting with each of the components.

The present disclosure applies the second slurry on the first layer to form the second layer before the first layer is dried to prevent the bonding interface being formed between the first layer and the second layer. In this case, it is preferable that the viscosity of the first slurry is the same as or similar to the viscosity of the second slurry. Here, the expression “before the first layer is dried” means when the first layer is in a wet state in which a solvent remains in the first layer. The bonding interface between the first layer and the second layer does not form because the first layer and the second layer fuse with each other when they are brought into contact in a wet state.

The cathode active material layer prepared as described above may be used to manufacture a laminated solid-solid-state battery illustrated in FIG. 1. For example, the anode current collector, the anode active material layer, the solid electrolyte layer, the cathode active material layer including the first layer and the second layer, and the cathode current collector may be sequentially stacked such that the first layer is positioned on the anode current collector side and the second layer is positioned on the solid electrolyte layer side.

Other forms of the disclosure will be described in more detail with reference to examples described below. The examples described below are presented only to help understanding of the present disclosure, and the scope of the present disclosure is not limited thereto.

### EXAMPLE

A cathode active material layer composed of a first layer and a second layer was prepared. In the cathode active material layer, the first layer included an amount of about 70% by weight of a fiber-type conductive material and an amount of about 30% by weight of a particle-type conductive material, and the second layer included an amount of about 20% by weight of a fiber-type conductive material and an amount of about 80% by weight of a particle-type conductive material. The amount of the fiber-type conductive material and the particle-type conductive material were determined based on a total amount of the conductive material contained in each layer. The amount of the binder in the first layer was about 1.3% by weight and the amount of the binder in the second layer was about 1.8% by weight.

The second layer was formed on the first layer before the first layer was dried such that no bonding interface was formed between the first layer and the second layer.

The ratio (d1/d2) of the thickness (d1) of the first layer to the thickness (d2) of the second layer was about 2:3.

### Comparative Example 1

A cathode active material layer was prepared in a manner that a first layer and a second layer were not distinguished. Specifically, the cathode active material layer of Comparative Example 1 includes an amount of about 70% by weight of a fiber-type conductive material and an amount of about 30% by weight of a particle-type conductive material based on the total amount of the conductive material contained in the cathode active material layer. The thickness of the cathode active material layer was the same as in Example.

### Comparative Example 2

A cathode active material layer was prepared in a manner that a first layer and a second layer were not distinguished. Specifically, the cathode active material layer of Comparative Example 2 includes an amount of about 20% by weight of a fiber-type conductive material and an amount of about 80% by weight of a particle-type conductive material based on the total amount of the conductive material contained in the cathode active material layer. The thickness of the cathode active material layer was the same as in Example.

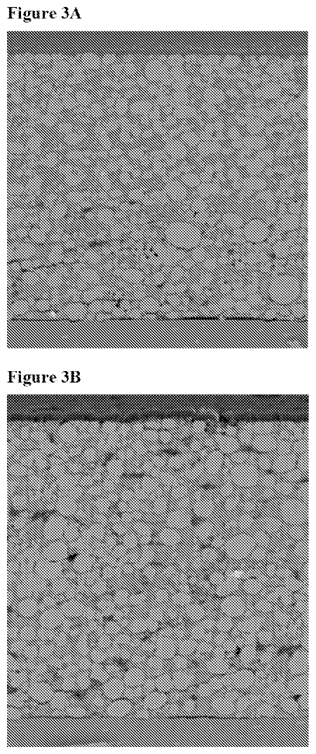

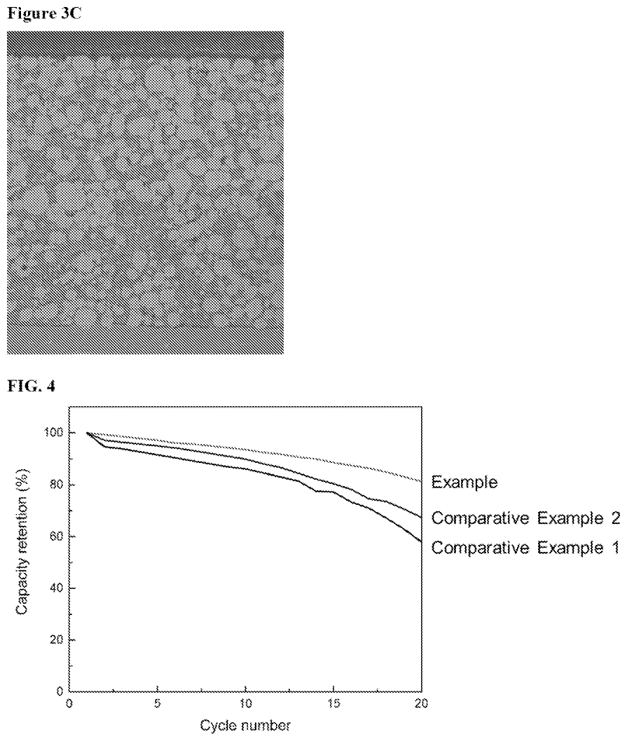

FIG. 3A shows a scanning electron microscope (SEM) image of a cross section of a cathode active material layer according to the present disclosure; FIG. 3B shows an SEM image of a cross section of a cathode active material layer according to Comparative Example 1; FIG. 3C shows an SEM image of a cathode active material layer according to Comparative Example 2;

Referring to FIG. 3A, the lower side (first layer) of the cathode active material layer prepared in Example exhibits characteristics similar to those of Comparative Example 1, and the upper side (second layer) of the cathode active material layer prepared in Example exhibits characteristics similar to those of Comparative Example 2. On the other hand, it is shown that no bonding interface was foamed between the first layer and the second layer.

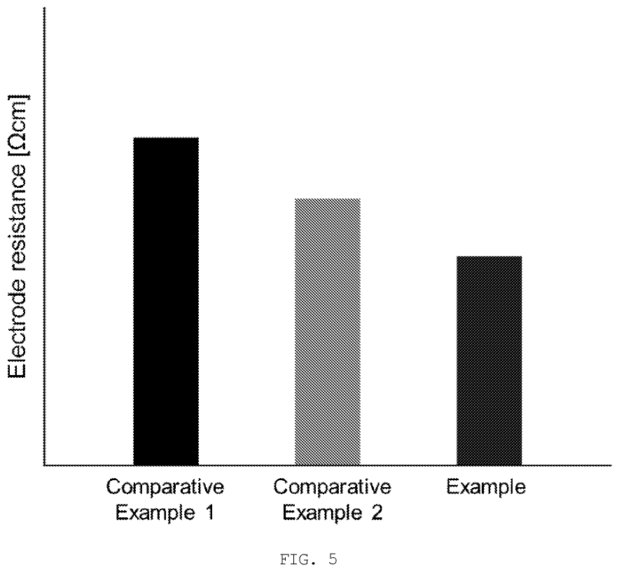

The cathode active material layers according to Example, Comparative Example 1, and Comparative Example 2 were used to construct all-solid-state batteries as shown in FIG. 1. The lifespan of each all-solid-state battery was measured. The results are shown in FIG. 4. Referring to FIG. 4, the lifespan of the battery according to Example is longer than those of Comparative Examples 1 and 2.

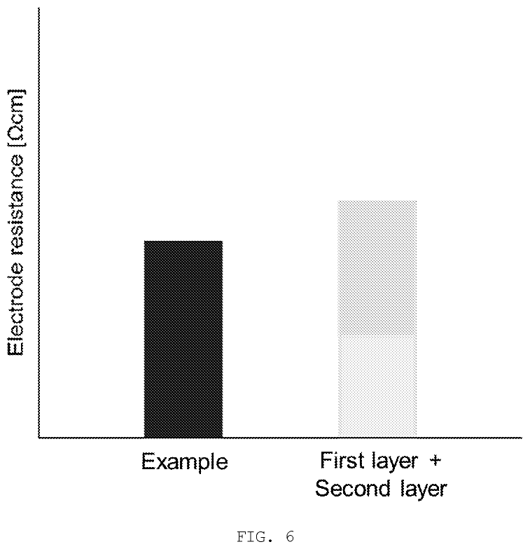

The resistance increase rate was measured after 20 cycles of charging and discharging of each all-solid-state battery. The results are shown in FIG. 5. Referring to FIG. 5, the increase in resistance of the battery according to Example is smaller than those of Comparative Examples 1 and 2.

In addition, the electrode resistance of the cathode active material layer according to Example was compared with the sum of the resistance of the first layer and the resistance of the second layer. The results are shown in FIG. 6. Referring to FIG. 6, the actual electrode resistance is smaller than the sum of the resistances of the first layer and the second layer. From this result, it is confirmed that the interfacial resistance of the cathode active material layer is reduced.

Although embodiments according to the present disclosure have been described for illustrative purposes, those skilled in the art will appreciate that various modifications, additions and substitutions are possible, without departing from the scope and spirit of the disclosure as disclosed in the appended claims

What is claimed is:

1. A all-solid-state battery comprising an anode current collector, an anode active material layer, a solid electrolyte layer, a cathode active material layer, and a cathode current collector that are sequentially stacked,
wherein the cathode active material layer comprises:
a first layer disposed on the cathode current collector and comprising a fiber-type conductive material and a particle-type conductive material; and
a second layer disposed on the solid electrolyte layer and comprising the fiber-type conductive material and the particle-type conductive material, and
wherein the first layer has a higher first amount of the fiber-type conductive material than a first amount of the particle-type conductive material, and the second layer has a higher second amount of the particle-type conductive material than a second amount of the fiber-type conductive material.

2. The all-solid-state battery according to claim 1, wherein specific surface area of the fiber-type conductive material is equal to or less than one quarter of specific surface area of the particle-type conductive material.

3. The all-solid-state battery according to claim 1, wherein the first layer comprises an amount of about 60% to 90% by weight of the fiber-type conductive material and an amount of about 10% to 40% by weight of the particle-type conductive material based on a total amount of the fiber-type conductive material and the particle-type conductive material in the first layer.

4. The all-solid-state battery according to claim 1, wherein the second layer comprises an amount of about 10% to 40% by weight of the fiber-type conductive material and an amount of about 60% to 90% by weight of the particle-type conductive material based on a total amount of the fiber-type conductive material and the particle-type conductive material in the second layer.

5. The all-solid-solid-state battery according to claim 1, wherein the cathode active material layer has a thickness of about 100 μm to 350 μm.

6. The all-solid-state battery according to claim 1,
wherein the ratio (d1/d2) of a thickness (d1) of the first layer to a thickness (d2) of the second layer is in a range of about 0.5 to 1.

7. The all-solid-solid-state battery according to claim 1, wherein the first layer has a thickness of about 50 μm to 150 μm.

8. The all-solid-solid-state battery according to claim 1, wherein the second layer has a thickness of about 50 μm to 200 μm.

9. The all-solid-state battery according to claim 1, wherein the cathode active material layer comprises no bonding interface between the first layer and the second layer.

10. The all-solid-state battery according to claim 1,
wherein the first layer further comprises a binder, and the amount of the binder satisfies Equation 1:
an amount of the binder in the first layer [% by weight]=2 [% by weight]−the first amount of the fiber-type conductive material [% by weight] based on a total amount of the fiber-type conductive material and the particle-type conductive material in the first layer/100. [Equation 1]

11. The all-solid-state battery according to claim 1, wherein the second layer further comprises a binder, and the amount of the binder satisfies Equation 2:
an amount of the binder in the second layer [% by weight] =2 [% by weight]−the second amount of the fiber-type conductive material [% by weight] based on a total amount of the fiber-type conductive material and the particle-type conductive material in the second layer/100. [Equation 2]

12. A method of manufacturing an all-solid-state battery, the method comprising:
preparing a first slurry comprising a cathode active material, a solid electrolyte, a binder, a fiber-type conductive material, and a particle-type conductive material at first predetermined amounts;
preparing a second slurry comprising the cathode active material, the solid electrolyte, the binder, the fiber-type conductive material, and the particle-type conductive material at second predetermined amounts;
applying the first slurry onto a substrate to form a first layer; and
applying the second slurry onto the first layer before the first layer is dried, to form a second layer,
wherein an anode current collector, an anode active material layer, a solid electrolyte layer, a cathode active material layer including the first layer and the second layer, and a cathode current collector are sequentially stacked such that the first layer is disposed on the cathode current collector side and the second layer is disposed on the solid electrolyte layer, and
the first layer has a higher first amount of the fiber-type conductive material than a first amount of the particle-type conductive material, and the second layer has a second higher amount of the particle-type conductive material than a second amount of the fiber-type conductive material.

13. The method according to claim 12, wherein the specific surface area of the fiber-type conductive material is equal to or less than one quarter of the specific surface area of the particle-type conductive material.

14. The method according to claim 12, wherein the first layer comprises an amount of about 60% to 90% by weight of the fiber-type conductive material and an amount of about 10% to 40% by weight of the particle-type conductive material based on a total amount of the fiber-type conductive material and the particle-type conductive in the first layer, and
the second layer comprises an amount of about 10% to 40% by weight of the fiber-type conductive material and an amount of about 60% to 90% by weight of the particle-type conductive material based on a total amount of the fiber-type conductive material and the particle-type conductive material in the second layer.

15. The method according to claim 12, wherein the cathode active material layer has a thickness of about 100 μm to 350 μm.

16. The method according to claim 12, wherein the ratio (d1/d2) of the thickness (d1) of the first layer to the thickness (d2) of the second layer is in a range of about 0.5 to 1.

17. The method according to claim 12, wherein the first layer has a thickness of about 50 μm to 150 μm, and the second layer has a thickness of about 50 μm to 200 μm.

18. The method according to claim 12, wherein the first layer and the second layer are integrated without having a bonding interface.

19. The method according to claim 12, wherein the first layer further comprises a binder, and the amount of the binder satisfies Equation 1:
an amount of the binder in the first layer [% by weight]=2 [% by weight]−the first amount of the fiber-type conductive material [% by weight] based on a total amount of the fiber-type conductive material and the particle-type conductive material in the first layer/100. [Equation 1]

20. The method according to claim 12, wherein the second layer further comprises a binder, and the amount of the binder satisfies Equation 2:
an amount of the binder in the second layer [% by weight] =2 [% by weight]−the second amount of the fiber-type conductive material [% by weight] based on a total amount of the fiber-type conductive material and the particle-type conductive material in the second layer/100. [Equation 2]
